(19) United States
(12) Patent Application Publication
(10) Pub. No.: US 2006/0262928 A1
(43) Pub. Date: Nov. 23, 2006

(54) Method, device, and system of encrypting/decrypting data

(76) Inventors: Hagai Bar-El, Rehovot (IL); Aviram Yeruchami, Kfar Saba (IL); David Deitcher, Jerusalem (IL)

Correspondence Address: PEARL COHEN ZEDEK, LLP, 1500 BROADWAY 12TH FLOOR, NEW YORK, NY, 10036, US

(21) Appl. No.: 11/437,728

(22) Filed: May 22, 2006

Related U.S. Application Data
(60) Provisional application No. 60/683,311, filed on May 23, 2005.

(51) Int. Cl. H04N 7/167

(52) U.S. Cl. 380/228

(57) ABSTRACT

Some demonstrative embodiments of the invention include a method, device and/or system to encrypt and/or decrypt data. In one demonstrative embodiment, the device may include, for example, a storage; and an encryption/decryption module to: receive externally-encrypted data to be stored in the storage, wherein the externally-encrypted data is encrypted using an external key; decrypt the externally-encrypted data using the external key to generate decrypted data; and encrypt the decrypted data using a securely maintained internal key to generate internally-encrypted data. Other embodiments are described and claimed.

### CROSS REFERENCE TO RELATED APPLICATIONS

This application claims priority of U.S. Provisional Application No. 60/683,311, filed May 23, 2005, the entire disclosure of which is incorporated herein by reference.

### BACKGROUND OF THE INVENTION

Conventional computing systems may include a host having a storage device to store data, e.g., in the for of one or more files.

A secure session may be established between the host and a server to enable the server to securely provide the host with data to be stored in the storage. During the secure session, the server may encrypt the data to be stored using a session key, which may be known to the server and the host. A different session key may be used during different sessions. The host may receive the encrypted data, and may decrypt the data using the session key. The decrypted data may be stored in the storage.

In order to secure the data stored in the storage, the host may include a “physical” protection structure to prohibit any access to the stored data. However, the protection structure may be relatively complex and/or expensive and, thus, may not provide cost-effective protection for large amounts of data.

### SUMMARY OF SOME DEMONSTRATIVE EMBODIMENTS OF THE INVENTION

Some demonstrative embodiments of the invention include a method, device and/or system of encrypting/decrypting data.

According to some demonstrative embodiments of the invention, the device may include a storage; and an encryption/decryption module to: receive externally-encrypted data to be stored in the storage, wherein the externally-encrypted data is encrypted using an external key; decrypt the externally-encrypted data using the external key to generate decrypted data; and/or encrypt the decrypted data using a securely maintained internal key to generate internally-encrypted data.

According to some demonstrative embodiments of the invention, the encryption/decryption module may include an encryptor/decryptor having an encryption mode of operation to encrypt data received at a data input of the encryptor/decryptor using a key received at a key input of the encryptor/decryptor, and a decryption mode of operation to decrypt data received at the data input using a key received at the key input. The encryptor/decryptor module may also include a controller to set the encryptor/decryptor to the decryption mode of operation, and provide the externally-encrypted data and the external key to the data input and the key input, respectively, to generate the decrypted data. The Controller may also set the encryptor/decryptor to the encryption mode, and provide the decrypted data and the internal key to the data input and the key input, respectively, to generate the internally-encrypted data. According to some demonstrative embodiments of the invention, the encryption/decryption module may also include a first selector to selectively provide one of the internal key and the external key to the key input; and a second selector to selectively provide one of the externally-decrypted data and the output of the encryptor/decryptor to the data input.

According to some demonstrative embodiments of the invention, the encryptor/decryptor may include a symmetric encryption/decryption engine.

According to some demonstrative embodiments of the invention, the encryption/decryption module may decrypt the internally-encrypted data using the first key to generate the decrypted data; and encrypt the decrypted data using an external key known to a requestor of the internally-encrypted data. According to some demonstrative embodiments of the invention, the encryption/decryption module may include an encryptor/decryptor having an encryption mode of operation to encrypt data received at a data input of the encryptor/decryptor using a key received at a key input of the encryptor/decryptor, and a decryption mode of operation to decrypt data received at the data input using a key received at the key input. The encryption/decryption module may also include a controller to set the encryptor/decryptor to the decryption mode of operation, and provide the internally-encrypted data and the internal key to the data input and the key input, respectively, to generate the decrypted data; and set the encryptor/decryptor to the encryption mode, and provide the decrypted data and the external key known to the requestor to the data input and the key input, respectively. According to some demonstrative embodiments of the invention, the external key known to the requestor may include the external key used to encrypt the externally-encrypted data. According to other demonstrative embodiments of the invention, the external key known to the requestor may include a key different than the external key used to encrypt the externally-encrypted data.

According to some demonstrative embodiments of the invention, the encryption/decryption module may include first and second registers to maintain the internal and external keys, respectively.

According to some demonstrative embodiments of the invention, the externally-encrypted data may be encrypted using a session key of a secure session.

According to some demonstrative embodiments of the invention, the encryption/decryption module may receive other externally-encrypted data to be stored in the storage; decrypt the other externally-encrypted data to generate other decrypted data; encrypt the other decrypted data using the internal key to generate other internally-encrypted data; and store the other internally-encrypted data in the storage.

According to some demonstrative embodiments of the invention, the encryption/decryption module may receive other externally-encrypted data to be stored in the storage; decrypt the other externally-encrypted data to generate other decrypted data; encrypt the other decrypted data using another internal key to generate other internally-encrypted data; and store the other internally-encrypted data in the storage.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a computing system including a storage device according to some demonstrative embodiments of the invention;

FIG. 2 is a schematic illustration of an encryption/decryption module according to some demonstrative embodiments of the invention; and

FIG. 3 is a schematic flowchart of a method of encrypting/decrypting data according to some demonstrative embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art. An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

Embodiments of the present invention may include apparatuses for performing the operations herein. These apparatuses may be specially constructed for the desired purposes, or they may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, a Dynamic RAM (DRAM), a Synchronous DRAM (SD-RAM), a Flash memory, a volatile memory, a non-volatile memory, a cache memory, a buffer, a short term memory unit, a long term memory unit, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

Part of the discussion herein may relate, for demonstrative purposes, to encrypting/decrypting a data file (“file”). However, embodiments of the invention are not limited in this regard, and may include, for example, securely storing a data block, a data portion, a data sequence, a data frame, a data field, a data record, data stream, a content, an item, a message, a key, a code, or the like.

Some demonstrative embodiments of the invention may include a method, device and/or system to encrypt/decrypt data to be stored in a storage device and/or data retrieved from the storage device. The data to be stored may include, for example, externally-encrypted data, which may be encrypted, e.g., by a provider of the data to be stored, using an external key. For example, the externally-encrypted data may be received, e.g., from a host or a server, during a first secure session and the external key may include, for example, a first session key. The externally-encrypted data may be decrypted, for example using the external key; and the decrypted data may be encrypted using an internal key to generate internally-encrypted data which may be stored in the storage, e.g., as described in detail below. The internal key may include, for example, a secret key which may be securely maintained, e.g., by a secure memory. The internally-encrypted data may be decrypted using the internal key; and the decrypted data may be encrypted using an external-key known to a requestor, e.g., the host or server, attempting to access the internally-encrypted data. The external key known to the requestor may include, for example a second session key, which may be different than or equal to the first session key. Although the invention is not limited in this respect, in some demonstrative embodiments of the invention, two or more different internal keys may be selectively used to encrypt two or more data files, based on any suitable criteria, e.g., as described in detail below.

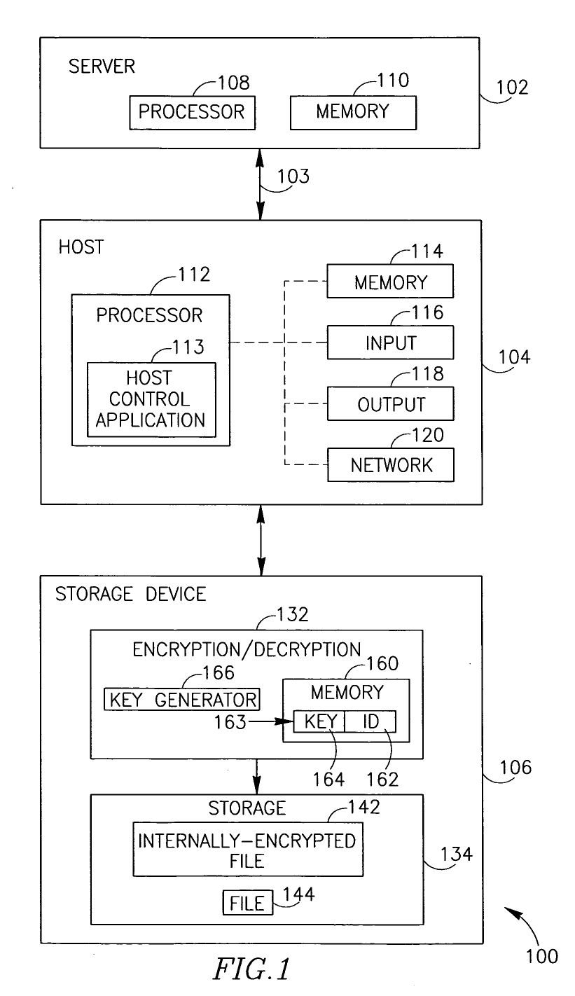

Reference is made to FIG. 1, which schematically illustrates a computing system 100 according to some demonstrative embodiments of the invention.

According to some demonstrative embodiments of the invention, system 100 may include a storage device 106 associated with a host 104, as are both described in detail below.

Although the present invention is not limited in this respect, host 104 may include or may be a portable device. Non-limiting examples of such portable devices include mobile telephones, laptop and notebook computers, personal digital assistants (PDA), and the like. Alternatively, host 104 may be a non-portable device, such as, for example, a desktop computer.

According to the demonstrative embodiments of FIG. 1, host 104 may include a host control application 113 to access, e.g., retrieve, one or more stored files from storage device 106, and/or to store one or more files in storage device 106. For example, host control application 113 may manage a file system stored in storage device 106. The file system may include, for example, a plurality of internally-encrypted files, e.g., as described in detail below. Host control application 113 may be implemented by any suitable software and/or instructions, which may be executed, for example, by a processor 112 associated with a memory 114. For example, host control application 113 may be implemented by host control application instructions (not shown), which may be stored in memory 114. Host 104 may optionally include an output unit 118, an input unit 116, a network connection 120, and/or any other suitable hardware components and/or software components.

According to some demonstrative embodiments of the invention, processor 112 may include a Central Processing Unit (CPU), a Digital Signal Processor (DSP), a microprocessor, a host processor, a plurality of processors, a controller, a chip, a microchip, or any other suitable multi-purpose or specific processor or controller. Input unit 116 may include, for example, a keyboard, a mouse, a touch-pad, or other suitable pointing device or input device. Output unit 118 may include, for example, a Cathode Ray Tube (CRT) monitor, a Liquid Crystal Display (LCD) monitor, or other suitable monitor or display unit. Memory 114 may include, for example, a RAM, a ROM, a DRAM, a SD-RAM, a Flash memory, a volatile memory, a non-volatile memory, a cache memory, a buffer, a short term memory unit, a long term memory unit, or other suitable memory units or storage units. Network connection 120 may be adapted to interact with a communication network, for example, a local—area network (LAN), wide area network (WAN), or a global communication network, for example, the Internet. According to some embodiments the communication network may include a wireless communication network such as, for example, a wireless LAN (WLAN) communication network. Although the scope of the present invention is not limited in this respect, the communication network may include a cellular communication network, with host 104 being, for example, a base station, a mobile station, or a cellular handset. The cellular communication network, according to some embodiments of the invention, may be a 3^{rd} Generation Partnership Project (3GPP), such as, for example, Frequency Domain Duplexing (FDD), Global System for Mobile communications (GSM), Wideband Code Division Multiple Access (WCDMA) cellular communication network and the like.

According to some demonstrative embodiments of the invention, system 100 may optionally include a server 102, e.g., a remote server, associated with host 104, for example, via a wired or wireless connection 103. Server 102 may perform one or more operations on data stored in storage device 106, e.g., during a secure session as described below. According to some demonstrative embodiments of the invention, server 102 may include a processor 108 associated with a memory 110. Processor 102 may include, for example, a Central Processing Unit (CPU), a Digital Signal Processor (DSP), a microprocessor, a host processor, a plurality of processors, a controller, a chip, a microchip, or any other suitable multi-purpose or specific processor or controller. Memory 110 may include, for example, a RAM, a ROM, a DRAM, a SD-RAM, a Flash memory, a volatile memory, a non-volatile memory, a cache memory, a buffer, a short term memory unit, a long term memory unit, or other suitable memory units or storage units.

Although the present invention is not limited in this respect, storage device 106 may be a portable storage device, e.g., a portable memory card, a flashcard, a disk, a chip, a token, a smartcard, and/or any other portable storage device, which may be, for example, detachable from host 104. For example, host 104 may include, or may be, a mobile telephone or a cellular handset; and storage device 106 may include or may be, for example, a memory card detachable from the mobile telephone or handset. According to other embodiments, storage device 106 may be a non-portable storage device, for example, a memory card, e.g., a flashcard, a disk, chip, a token, a smartcard, and/or any other storage unit or element integrally connected to, or included within, host 104. For example, host 104 may include, or may be, a mobile telephone or a cellular handset; and storage device 106 may include or may be, for example, a memory embedded in the mobile telephone or handset.

According to demonstrative embodiments of the invention, storage device 106 may include a storage module 134 to store data, e.g., one or more files, which may be received, for example, from server 102, processor 112, memory 114, input unit 116, network connection 120, any other suitable component of host 104, and/or any other suitable unit or element associated with storage device 106, e.g., as described below.

According to some demonstrative embodiments of the invention, storage module 134 may include, for example, a RAM, a DRAM, a SD-RAM, a Flash memory, or any other suitable, e.g., non-volatile, memory or storage. Storage module 134 may store at least one internally-encrypted file 142. Storage module 134 may optionally store one or more other files 144, e.g., non-encrypted files, and/or externally-encrypted files.

According to demonstrative embodiments of the invention, storage device 106 may also include an encryption/decryption module 132 to encrypt and/or decrypt data, e.g., of a data stream, using two different keys, e.g., as described in detail below. According to other demonstrative embodiments of the invention, encryption decryption module 132 and/or storage device 106 may be implemented as part of host 104.

According to some demonstrative embodiments of the invention, encryption/decryption module 132 may receive a data stream encrypted by a first key; decrypt the data stream, e.g., internally; and encrypt the decrypted data stream using a second key. For example, encryption/decryption module 132 may encrypt/decrypt one or more externally-encrypted files to generate one or more internally-encrypted files to be stored in storage module 134; and/or one encrypt/decrypt or more internally-encrypted files retrieved from storage module 134 to generate one or more externally-encrypted files, e.g., as described in detail below.

According to demonstrative embodiments of the invention, encryption/decryption module 132 may include any suitable protection mechanism, e.g., any suitable “physical” protection structure and/or any other suitable protection configuration as is known in the art, to prevent unauthorized disclosure of any part of the contents of module 132; to prevent any attempt to access any part of the contents of module 132; to prevent any attempt to tamper or alter the contents of module 132, in part or in whole; and/or to prevent any attempt to interfere with the operation of module 132.

It will be appreciated that the term “preventing unauthorized disclosure of stored data” as used herein may refer to ensuring the stored data may not be understood without authorization, for example, even if access, e.g., partial or complete physical and/or electronic access, to the stored data is obtained. It will also be appreciated that the term “securely maintaining data” as used herein may refer to maintaining data, while preventing unauthorized disclosure of the maintained data.

According to some demonstrative embodiments of the invention, encryption/decryption module 132 may receive externally-encrypted data to be stored in storage module 134. The externally-encrypted data may be encrypted, for example, using an external key. In one example, host 104 or server 102 may generate the external key, and may provide the external key to storage device 106, e.g., during a secure session. In another example, the external key may be generated by storage device 106, e.g., by encryption/decryption module 132, and provided to host 104 or server 102, e.g., during a secure session. Although the invention is not limited in this respect, the external key may include, for example, a secure session key, which may be used during a secure session between encryption/decryption module 132 and host 104 or server 102, e.g., as is known in the art. Although the invention is not limited in this respect, first and second externally-encrypted data may be encrypted using first and second different external keys, for example, if the first and second externally-encrypted data are received from different sources, the first and second externally-encrypted data are received during different secure sessions, and/or the first and second externally-encrypted data relate to different files and/or users.

According to some demonstrative embodiments of the invention, encryption/decryption module 132 may decrypt the externally-encrypted data, e.g., using the external key, to generate decrypted data; and encrypt the decrypted data using an internal key to generate internally-encrypted data, which may be stored, for example by storage module 134, e.g., as described in detail below.

Although the present invention is not limited in this respect, storage module 134 may be, for example, integrally connected to encryption/decryption module 132. According to other embodiments, storage module 134 may be detachable from encryption/decryption module 132. According to yet other embodiments, storage module 134 may be integrally connected to host 104.

Although the invention is not limited in this respect, according to some demonstrative embodiments of the invention, host 104 may manage a file system including a plurality of encrypted files stored by storage 134, e.g., including internally-encrypted file 142. For example, host 104 may implement any suitable file management method or algorithm to manage the file system of storage 134, e.g., as is known in the art. Encryption/decryption module 132 may decrypt data blocks and/or portions of an externally-decrypted file received form host 104 to generate decrypted data; and encrypt the decrypted data to generate internally-encrypted data corresponding to the externally-encrypted data, for example, while the file is being stored in storage 134, e.g., by host 104. Additionally or alternatively, encryption/decryption module 132 may decrypt data blocks and/or portions of a stored internally-encrypted file, e.g., file 142, to generate decrypted data; and encrypt the decrypted data to generate externally-encrypted data corresponding to the internally-encrypted data, for example, while the file is being accessed or retrieved from storage 134, e.g., by host, 104, as described in detail below.

According to some demonstrative embodiments of the invention, encryption/decryption module 132 may include a key generator 166 and a memory 160. Key generator 166 may generate, e.g., randomly or substantially randomly, at least one secret key to be stored in memory 160, e.g., as at least one internal key 164. The secret key may include, for example, a secret file key, i.e., a block of bits of a predetermined length, e.g., 128 bits, corresponding, for example, to a cipher algorithm implemented by encryption/decryption module 132. Key generator 166 may include any suitable key generator, e.g., as is known in the art.

According to some demonstrative embodiments of the invention, memory 160 may include, for example, a RAM, a DRAM, an SD-RAM, a Flash memory, or any other suitable non-volatile, memory or storage. According to some demonstrative embodiments, storage 134 may be able to store a relatively large amount of data, e.g., compared to the amount of data that may be stored in memory 160.

Although the invention is not limited in this respect, according to some demonstrative embodiments of the invention, memory 160 may maintain a plurality of internal keys associated with a plurality of internally-encrypted files. The internal keys may be associated with the internally-encrypted files based on any suitable criteria, for example, based on an identity of one or more users intended to access the files, an identity of one or more hosts intended to retrieve the files, an identity of one or more servers intended to access the files, and/or any other suitable criterion. Although the invention is not limited in this respect, memory 160 may maintain, for example, at least one table 163 including one or more ID values 162 associated with at least one key 164. ID values 162 may indicate, for example, one or more internally-encrypted files, e.g., including file 142, associated with key 164. For example, ID value 162 may include an indication of at least one address of at least one file, e.g., file 142, which is internally-encrypted using internal key 164. Encryption/decryption module 132 may update, for example, ID value 162 to indicate internally-encrypted file 142 is encrypted using internal key 164, e.g., while generating file 142. According to some demonstrative embodiments of the invention, table 163 may be stored as an encrypted file in storage 134. For example, table 163 may be encrypted using a secret table key (not shown), which may be stored in encryption/decryption module 132. The secret table key may be used to encrypt/decrypt data of table 163.

According to some demonstrative embodiments of the invention, server 102 may provide host 104 with a first externally-encrypted file to be stored in storage 134, e.g., during a first secure session using a first session key. The first externally-encrypted file may be encrypted by server 102 using a first external key, e.g., the first session key. Encryption/decryption module 132 may receive from host 104 the first externally-encrypted file, and generate a first internally-encrypted file to be stored in storage 134. The first internally-encrypted file may be encrypted using a first internal key, which may be stored, for example, in memory 160. An ID value indicating the first internally-encrypted file may also be stored in memory 160, e.g., in association with the first internal key. Server 102 may provide host 104 with a second externally-encrypted file to be stored in storage 134, e.g., during the first secure session using the session key. The second externally-encrypted file may be encrypted by server 102, e.g., using the first external key. Encryption/decryption module 132 may receive from host 104 the second externally-encrypted file, and generate a second internally-encrypted file to be stored in storage 134. The second internally-encrypted file may be encrypted using the first internal key. An ID value indicating the second internally-encrypted file may also be stored in memory 160, e.g., in association with the first internal key. Alternatively, encryption/decryption module 132 may generate the second internally-encrypted file using another internal key, e.g., different than the first internal key; and the ID value indicating the second internally-encrypted file may be stored in memory 160, e.g., in association with the other internal key. Server 102 may provide host 104 with a third externally-encrypted file to be stored in storage 134, e.g., during a second secure session using a second session key. The third externally-encrypted file may be encrypted by server 102, e.g., using a second external key, e.g., the second session key. Encryption/decryption module 132 may receive from host 104 the third externally-encrypted file, and generate a third internally-encrypted file to be stored in storage 134. The third internally-encrypted file may be encrypted using a second internal key, e.g., different than the first internal key. An ID value indicating the third internally-encrypted file may also be stored in memory 160, e.g., in association with the second internal key. The first and/or second internal keys may be generated, for example, by key generator 166.

According to some demonstrative embodiments of the invention server 102 may control the storage of data in storage device 106, and encryption/decryption module 132 may manage the data stored in storage module 134. Although the invention is not limited in this respect, encryption/decryption module 132 may use different internal keys to encrypt one or more data files stored in storage module 134, e.g., in order to keep each data file secure independent of other data files. When a data file is accessed, e.g., by server 102, encryption/decryption module 132 may retrieve the internal key from memory 160, e.g., based on an index identifying the accessed file; and decrypt the accessed data file using the retrieved internal key. Although the invention is not limited in this respect, the same internal key may be used, for example, for a plurality of accesses, e.g., all accesses, to the same data file. A secure session may be set up between server 102 and host 104 in order, for example, to support access by server 102 to storage module 134. During the secure session, a temporary encryption key may be used, e.g., for each session. The session key may change from session to session. Therefore, in order for server 102 to access a stored data file in storage module 134, encryption/decryption module 132 may decrypt the data file using the internal key which may be securely maintained by memory 160; and encrypt the decrypted data file using the temporary session key, before providing the data file to server 102.

According to some demonstrative embodiments of the invention, it may be desired not to use the internal key as the session key between host 104 and server 102, e.g., because this may expose the internal key to attacks, since it may be frequently used in communications between server 102 and host 104. On the other hand, it may be desired not to use the temporary session key to encrypt the data files stored in storage module 134, e.g., because this may require decrypting and re-encrypting the decrypted file with a new session key, e.g., for each access. Some demonstrative embodiments of the invention may include using both the internal key, e.g., to securely encrypt/decrypt data stored in storage device 106, and the external key, e.g., the temporary session key, to encrypt data transferred between device 106 and a requestor of the data file, e.g., server 102, as described in detail above.

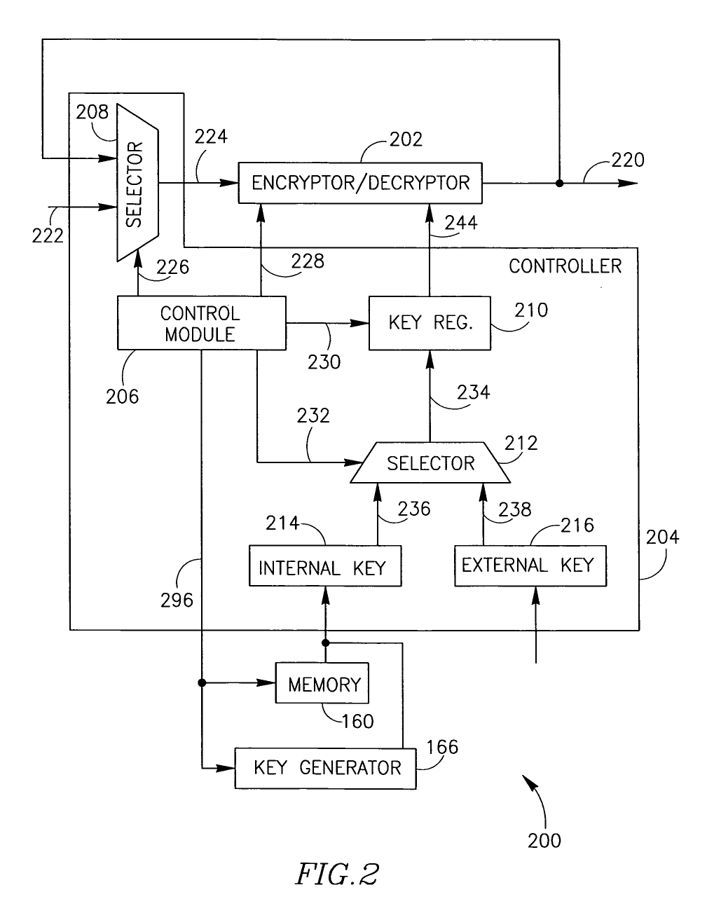

Reference is now made to FIG. 2, which schematically illustrates an encryption/decryption module 200 according to some demonstrative embodiments of the invention. Although the invention is not limited in this respect, encryption/decryption module 200 may perform the functionality of encryption/decryption module 132 (FIG. 1).

According to some demonstrative embodiments of the invention, encryption/decryption module 200 may have first and second modes of operation. At the first mode of operation, encryption/decryption module 200 may receive at an input 222 externally-encrypted data to be stored, for example, in storage 134 (FIG. 1), wherein the externally-encrypted data may be encrypted using an external key; and generate at an output 220 internally-encrypted data encrypted using an internal key. At the second mode of operation, encryption/decryption module 200 may receive at input 222 stored internally-encrypted data retrieved, for example, from storage 134 (FIG. 1), wherein the stored internally-encrypted data may be encrypted using an internal key; and generate at output 220 externally-encrypted data encrypted using an external key known to a requester attempting to access the stored data.

According to some demonstrative embodiments of the invention, encryption/decryption module 200 may include an encryptor/decryptor 202, which may have, for example, an encryption mode of operation and a decryption mode of operation. At the encryption mode of operation, encryptor/decryptor 202 may encrypt data received at a data input 224 of encryptor/decryptor 202 using a key received at a key input 244 of encryptor/decryptor 202. At the decryption mode of operation, encryptor/decryptor 202 may decrypt data received at data input 224 using a key received at key input 244. For example, encryptor/decryptor 202 may include a symmetric encryption/decryption engine, e.g., as is known in the art. The encryption decryption engine may implement, for example, an Advanced Encryption Standard (AES) cipher, e.g., an AES-CTR cipher algorithm, or any other suitable encryption/decryption algorithm as is known in the art.

According to some demonstrative embodiments of the invention, encryption/decryption module 200 may also include a controller 204 to selectively set encryptor/decryptor 202 to the encryption mode of operation or the decryption mode of operation, e.g., using control signal 228, as described below.

According to some demonstrative embodiments of the invention, at the first mode of operation of encryption/decryption module 200, controller 204 may, for example, set encryptor/decryptor 202 to the decryption mode of operation, and provide the externally-encrypted data to data input 224 and the external key to key input 244. Accordingly, output 220 may include decrypted data corresponding to the externally-encrypted data. Controller 204 may also set encryptor/decryptor 202 to the encryption mode of operation, and provide the decrypted data to data input 224 and the internal key to key input 244. Accordingly, output 220 may include the internally-encrypted data corresponding to the externally-encrypted data

According to some demonstrative embodiments of the invention, at the second mode of operation of encryption/decryption module 200, for example, controller 204 may set encryptor/decryptor 202 to the decryption mode of operation, and provide the stored internally-encrypted data to data input 224 and the internal key to key input 244. Accordingly, output 220 may include decrypted data corresponding to the stored internally-encrypted data. Controller 204 may also set encryptor/decryptor 202 to the encryption mode of operation, and provide the decrypted data to data input 224 and the external key known to the requestor to key input 244. Accordingly, output 220 may include the externally-encrypted data encrypted using the external key known to the requester.

According to some demonstrative embodiments of the invention, controller 204 may include a control module 206; and a selector 208 having a first input associated with input 222, a second input associated with output 220, and an output associated with data input 224. Control module 206 may control selector 208, e.g., using control signal 226, to selectively provide either output 220 or input 222 to data input 224. For example, control module 206 may control selector 208 to provide input 222 to input 224, e.g., when encryptor/decryptor 202 is at the decryption mode of operation; or to provide output 220 to input 224, e.g., when encryptor/decryptor 202 is at the encryption mode of operation.

According to some demonstrative embodiments of the invention, controller 204 may also include a first register 214 to store the internal key, and a second register to store the external key. The internal key may be retrieved from memory 160 or generated by generator 166. For example, control module 206 may control memory 160, e.g., using signals 296, to provide the internal key to register 214, if the internal key is stored in memory 160, for example, if the internal key is to be used to decrypt internally-encrypted data stored in storage 134 (FIG. 1). Alternatively, control module 206 may control generator 166, e.g., using signals 296, to generate the internal key and provide internal key to register 214, for example, e.g., if the internal key is not already stored in memory 160. In another example, control module 206 may retrieve the secret table key from memory 160, decrypt table 163 using the secret table key, and provide the internal key to register 214, e.g., if table 163 is encrypted and stored in storage 134.

According to some demonstrative embodiments of the invention, controller 204 may also include a selector 212 to select between a first input 236 from register 214 and a second input 238 from register 216, e.g., based on a control signal 232 from control module 206. Controller 204 may also include a third register to maintain an output 234 of selector 212. Control module 206 may control register 210, e.g., using a control signal 230, to provide key input 244 with the content of register 210.

According to some demonstrative embodiments of the invention, at the first mode of operation, input 222 may include the externally-encrypted data to be stored in storage module 134 (FIG. 1), register 216 may include the external key used to encrypt the externally-encrypted data, and register 214 may include the internal key to be used to generate the internally-encrypted data corresponding to the externally-encrypted data Control module 206 may set encryptor/decryptor 202 to the decryption mode of operation, control selector 212 to select input 238 including the external key of register 216, control selector 208 to provide input 222 to data input 224, and control register 210 to provide the external key to key input 244. After encryptor/decryptor decrypts the externally-decrypted data, control module 206 may set encryptor/decryptor 202 to the encryption mode of operation, control selector 212 to select input 236 including the internal key of register 214, control selector 208 to provide output 220 to data input 224, and control register 210 to provide the internal key to key input 244. Accordingly, encryptor/decryptor 202 may generate the internally-encrypted data at output 220.

According to some demonstrative embodiments of the invention, at the second mode of operation, input 222 may include the stored internally-encrypted data, data register 216 may include the external key known to the requestor, and register 214 may include the internal key used to encrypt the stored internally-encrypted data. Control module 206 may set encryptor/decryptor 202 to the decryption mode of operation, control selector 212 to select input 236 including the internal key of register 214, control selector 208 to provide input 222 to data input 224, and control register 210 to provide the internal key to key input 244. After encryptor/decryptor decrypts the stored internally-decrypted data, control module 206 may set encryptor/decryptor 202 to the encryption mode of operation, control selector 212 to select input 238 including the external key of register 216, control selector 208 to provide output 220 to data input 224, and control register 210 to provide the external key to key input 244. Accordingly, encryptor/decryptor 202 may generate the externally-encrypted data at output 220.

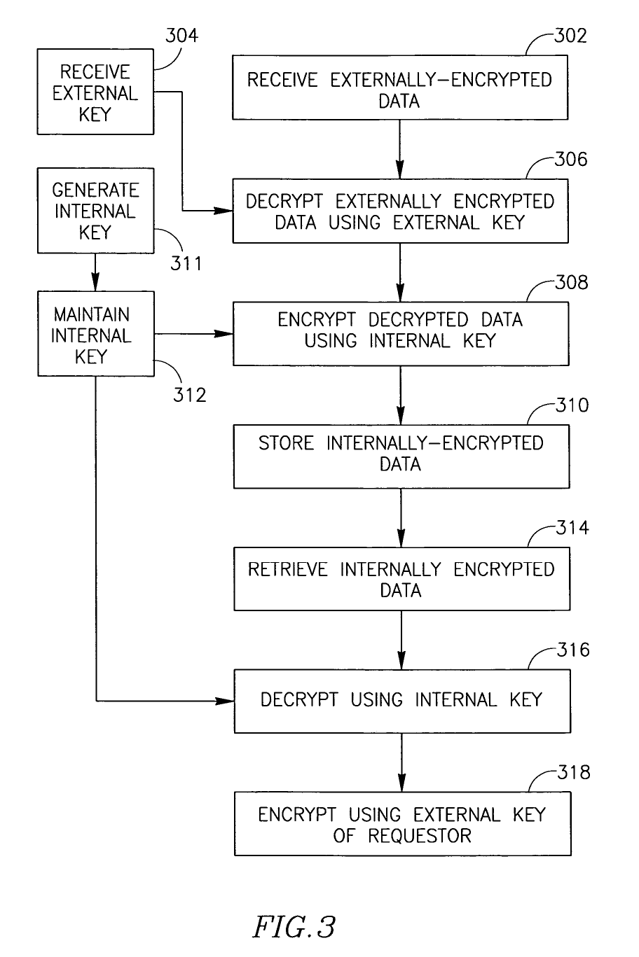

Reference is now made to FIG. 3, which schematically illustrates a method of encrypting decrypting data according to some demonstrative embodiments of the invention. Although the invention is not limited in this respect, one or more operations of the method of FIG. 3 may be implemented by system 100 (FIG. 1), server 102 (FIG. 1), host 104 (FIG. 1), storage device 106 (FIG. 1), encryption/decryption module 132 (FIG. 1), encryption/decryption module 200 (FIG. 2), controller 204 (FIG. 2), and/or encryptor/decryptor 202 (FIG. 2).

As indicated at block 302, the method may include receiving externally-encrypted data, which may be encrypted, for example, using an external key. For example, storage device 106 (FIG. 1) may receive the externally-encrypted data from host 104 (FIG. 1), server 102 (FIG. 1), or any other suitable source internal or external to system 100 (FIG. 1), e.g., as described above. Although the invention is not limited in this respect, the externally-encrypted data may be received, for example, during a secure session. The external key may include, for example, a session key of the secure session, e.g., as described above with reference to FIG. 1.

As indicated at block 304, the method may include according to some demonstrative embodiments of the invention, receiving the external key. For example, storage device 106 (FIG. 1) may receive the external key from the source of the externally-encrypted data. Alternatively, the external key may be generated, for example, by storage device 106 (FIG. 1), e.g., as described above with reference to FIG. 1. The external key may be generated using any other suitable method. For example, the external key may correspond to a combination of data received from the source of the externally-encrypted data and data generated by storage device 106 (FIG. 1).

As indicated at block 306, the method may include decrypting the externally-encrypted data using the external key to generate decrypted data. For example, encryption/decryption module 132 (FIG. 1) may decrypt the externally-encrypted data using the external key.

As indicated at block 308, the method may also include encrypting the decrypted data using an internal key to generate internally-encrypted data. For example, encryption/decryption module 132 (FIG. 1) may encrypt the decrypted data using the external key.

As indicated at block 311, the method may also include generating the internal key. For example, key generator 166 (FIG. 1) may generate the internal key. As indicated at block 312, the internal key may be maintained, e.g., securely. For example, memory 160 (FIG. 1) may maintain the internal key. Alternatively, the internal key may be maintained in storage 134 (FIG. 1) in encrypted form, e.g., using the secret table key as described above. One or more internal keys may be generated, maintained, and/or associated with one or more internally-encrypted files, e.g., based on any suitable criteria, as described above with reference to FIG. 1.

As indicated at block 310, the method may also include storing the internally-encrypted data. For example, the internally-encrypted data may be stored in storage 134 (FIG. 1), e.g., as internally-encrypted file 142 (FIG. 1), for example, by encryption/decryption module 132 (FIG. 1), host 104 (FIG. 1), and/or server 102 (FIG. 1).

As indicated at block 314, the method may also include retrieving the internally-encrypted data. For example, host 140 (FIG. 1), and/or server 102 (FIG. 1) may request access to the internally-encrypted data, e.g., as described above with reference to FIG. 1.

As indicated at block 316, the method may include decrypting the internally-encrypted data using the internal key. For example, encryption/decryption module 132 (FIG. 1) may decrypt the internally-encrypted data, e.g., as described above with reference to FIG. 1.

As indicated at block 318, the method may also include encrypting the decrypted data using an external key known to the requestor. For example, encryption/decryption module 132 may encrypt the decrypted data using a session key of a secure session with server 102 (FIG. 1), e.g., as described above with reference to FIG. 1.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. An apparatus to encrypt/decrypt data, the apparatus comprising:
a storage; and
an encryption/decryption module to:
receive externally-encrypted data to be stored in said storage, wherein said externally-encrypted data is encrypted using an external key;
decrypt said externally-encrypted data using said external key to generate decrypted data; and
encrypt said decrypted data using a securely maintained internal key to generate internally-encrypted data.

2. The apparatus of claim 1, wherein said encryption/decryption module comprises:
an encryptor/decryptor having an encryption mode of operation to encrypt data received at a data input of said encryptor/decryptor using a key received at a key input of said encryptor/decryptor, and a decryption mode of operation to decrypt data received at said data input using a key received at said key input; and
a controller to:
set said encryptor/decryptor to said decryption mode of operation, and provide said externally-encrypted data and said external key to said data input and said key input, respectively, to generate said decrypted data; and
set said encryptor/decryptor to said encryption mode, and provide said decrypted data and said internal key to said data input and said key input, respectively, to generate said internally-encrypted data.

3. The apparatus of claim 2, wherein said encryption/decryption module comprises:
a first selector to selectively provide one of said internal key and said external key to said key input; and
a second selector to selectively provide one of said externally-decrypted data and the output of said encryptor/decryptor to said data input.

4. The apparatus of claim 2, wherein said encryptor/decryptor comprises a symmetric encryption/decryption engine.

5. The apparatus of claim 1, wherein said encryption/decryption module is able to decrypt said internally-encrypted data using said first key to generate said decrypted data; and encrypt said decrypted data using an external key known to a requestor of the internally-encrypted data.

6. The apparatus of claim 5, wherein said encryption/decryption module comprises:
an encryptor/decryptor having an encryption mode of operation to encrypt data received at a data input of said encryptor/decryptor using a key received at a key input of said encryptor/decryptor, and a decryption mode of operation to decrypt data received at said data input using a key received at said key input; and
a controller to:
set said encryptor/decryptor to said decryption mode of operation, and provide said internally-encrypted data and said internal key to said data input and said key input, respectively, to gene rate said decrypted data; and
set said encryptor/decryptor to said encryption mode, and provide said decrypted data and the external key known to said requestor to said data input and said key input, respectively.

7. The apparatus of claim 5, wherein the external key known to said requester comprises the external key used to encrypt said externally-encrypted data.

8. The apparatus of claim 5, wherein the external key known to said requestor comprises a key different than the external key used to encrypt said externally-encrypted data.

9. The apparatus of claim 5, wherein said encryptor/decryptor comprises a symmetric encryption/decryption engine.

10. The apparatus of claim 1, wherein said encryption/decryption module comprises first and second registers to maintain said internal and external keys, respectively.

11. The apparatus of claim 1, wherein said externally-encrypted data is encrypted using a session key of a secure session.

12. The apparatus of claim 1, wherein said encryption/decryption module is able to receive other externally-encrypted data to be stored in said storage; decrypt said other externally-encrypted data to generate other decrypted data; encrypt said other decrypted data using said internal key to generate other internally-encrypted data; and store said other internally-encrypted data in said storage.

13. The apparatus of claim 1, wherein said encryption/decryption module is able to receive other externally-encrypted data to be stored in said storage; decrypt said other externally-encrypted data to generate other decrypted data; encrypt said other decrypted data using another internal key to generate other internally-encrypted data; and store said other internally-encrypted data in said storage.

14. A method of encrypting/decrypting data, the method comprising:
securely maintaining an internal key;
receiving externally-encrypted data to be stored in a storage, wherein said externally-encrypted data is encrypted with an external key;
decrypting said externally-encrypted data using said external key to generate decrypted data; and
encrypting said decrypted data using said internal key to generate internally-encrypted data.

15. The method of claim 14, wherein decrypting said externally-encrypted data comprises setting an encryptor/decryptor to a decryption mode of operation, and providing said externally-encrypted data to a data input of said encryptor/decryptor and said external key to a key input of said encryptor/decryptor to generate a first output; wherein encrypting said decrypted data comprises setting said encryptor/decryptor to an encryption mode of operation, and providing said first output and said internal key to said data input and said key input, respectively, to generate a second output; and wherein storing said internally-encrypted data comprises storing said second output.

16. The method of claim 14 comprising:
decrypting said internally-encrypted data using said first key to generate said decrypted data; and
encrypting said decrypted data using an external key known to a requester of the internally-encrypted data.

17. The method of claim 16, wherein encrypting said decrypted data using the external key known to said requestor comprises encrypting said decrypted data using the external key used to encrypt said externally-encrypted data.

18. The method of claim 16, wherein encrypting said decrypted data using the external key known to said requestor comprises encrypting said decrypted data using a key different than the key used to encrypt said externally-encrypted data.

19. The method of claim 16, wherein decrypting said internally-encrypted data comprises setting an encryptor/decryptor to a decryption mode of operation, and providing said internally-encrypted data to a data input of said encryptor/decryptor and said internal key to a key input of said encryptor/decryptor; wherein encrypting said decrypted data comprises setting said encryptor/decryptor to an encryption mode of operation, and providing said first output and the external key known to said requestor to said data input and said key input, respectively, to generate a second output; and wherein said method comprises providing said second output to said requester.

20. The method of claim 14, wherein receiving said externally-encrypted data comprises receiving said externally-encrypted data over a secure session using a session key, wherein said externally-encrypted data is encrypted using said session key.

21. The method of claim 14 comprising:
receiving other externally-encrypted data to be stored in said storage;
decrypting said other externally-encrypted data to generate other decrypted data;
encrypting said other decrypted data using said internal key to generate other internally-encrypted data; and
storing said other internally-encrypted data in said storage.

22. The method of claim 14 comprising:
receiving other externally-encrypted data to be stored in said storage;
decrypting said other externally-encrypted data to generate other decrypted data;
encrypting said other decrypted data using another internal key to generate other internally-encrypted data; and
storing said other internally-encrypted data in said storage.

23. The method of claim 14 comprising storing said internally-encrypted data.

24. A computing system comprising:
a storage;
a host to generate externally-encrypted data to be stored in said storage, said externally-encrypted data being encrypted using an external key; and
an encryption/decryption module to:
decrypt said externally-encrypted data using said external key to generate decrypted data; and
encrypt said decrypted data using a securely maintained internal key to generate internally-encrypted data.

25. The system of claim 24 comprising a server to establish a secure session with said encryption/decryption module using a session key, and to provide said externally-encrypted data to said host, wherein said external key comprises said session key.

26. The system of claim 24, wherein said encryption/decryption module comprises:
an encryptor/decryptor having an encryption mode of operation to encrypt data received at a data input of said encryptor/decryptor using a key received at a key input of said encryptor/decryptor, and a decryption mode of operation to decrypt data received at said data input using a key received at said key input; and
a controller to:
set said encryptor/decryptor to said decryption mode of operation, and provide said externally-encrypted data and said external key to said data input and said key input, respectively, to generate said decrypted data; and
set said encryptor/decryptor to said encryption mode, and provide said decrypted data and said internal key to said data input and said key input, respectively, to generate said internally-encrypted data.

27. The system of claim 24, wherein said encryption/decryption module is able to decrypt said internally-encrypted data using said first key to generate said decrypted data;
and encrypt said decrypted data using an external key known to a requestor of the internally-encrypted data.

28. An apparatus to encrypt/decrypt data, the apparatus comprising:
a storage to store internally-encrypted data, said internally encrypted data is encrypted using an internal key; and
an encryption/decryption module to:
decrypt said internally-encrypted data using a securely maintained internal key to generate decrypted data; and
encrypt said decrypted data using an external key to generate externally-encrypted data.

29. The apparatus of claim 28, wherein said encryption/decryption module comprises:
an encryptor/decryptor having an encryption mode of operation to encrypt data received at a data input of said encryptor/decryptor using a key received at a key input of said encryptor/decryptor, and a decryption mode of operation to decrypt data received at said data input using a key received at said key input; and
a controller to:
set said encryptor/decryptor to said decryption mode of operation, and provide said internally-encrypted data and said internal key to said data input and said key input, respectively, to generate said decrypted data; and
set said encryptor/decryptor to said encryption mode, and provide said decrypted data and said external key to said data input and said key input, respectively.
